(19) United States
(12) Patent Application Publication
(10) Pub. No.: US 2014/0186501 A1
(43) Pub. Date: Jul. 3, 2014

(54) Method for Coating a Food Product with a Water Soluble Flavoring

(71) Applicant: HORMEL FOODS CORPORATION, Austin, MN (US)

(72) Inventors: Nathan R. Smit, Brownsdale, MN (US); Brian K. Quandt, Austin, MN (US); Steven C. Wobschall, Austin, MN (US); William R. Dion, Austin, MN (US); Tony S. Muller, Austin, MN (US)

(73) Assignee: HORMEL FOODS CORPORATION, Austin, MN (US)

(21) Appl. No.: 13/804,167

(22) Filed: Mar. 14, 2013

Related U.S. Application Data
(60) Provisional application No. 61/748,638, filed on Jan. 3, 2013.

(51) Int. Cl. A23L 1/317

(52) U.S. Cl. CPC A23L 1/3172
USPC 426/302; 426/650; 426/641; 426/582; 426/646

(57) ABSTRACT

A method for coating a food product comprises placing a food product including fat and moisture in a vacuum mixer, applying low temperature heat to the food product to create a heated food product, the low temperature heat being below a melting point of the fat in the food product, applying vacuum to the heated food product, adding a first flavoring to the vacuum mixer, and applying vacuum to the heated food product and the first flavoring to create a first coated food product.

### CROSS-REFERENCE TO RELATED APPLICATION

This application claims the benefit of U.S. Provisional Application 61/748,638 filed Jan. 3, 2013, which is hereby incorporated by reference.

### BACKGROUND OF THE INVENTION

Coating food products including fat and moisture, such as pre-cooked, high-fat meat, with water soluble flavorings is challenging. One reason is because they include conflicting properties such as water and fat in the meat that dissolve the water soluble flavorings when heated during the coating process. This is especially true for water soluble flavorings with particle sizes of less than two inches.

For example, bacon and sugar have conflicting properties including water and fat in the bacon that make it challenging to produce a crunchy coating of sugar on the bacon when heated during the coating process. For example, utilizing conventional high temperature cooking methods to remove moisture causes the fat in the bacon to melt, which does not allow for the sugar to coat the bacon in an acceptable manner. In addition, for similar reasons, using conventional candy coating and spray coating techniques also do not result in acceptable products.

For the reasons stated above and for other reasons stated below, which will become apparent to those skilled in the art upon reading and understanding the present specification, there is a need in the art for a method of coating pre-cooked, high-fat meat with water soluble flavorings.

### BRIEF SUMMARY OF THE INVENTION

The above-mentioned problems associated with prior devices are addressed by embodiments of the present invention and will be understood by reading and understanding the present specification. The following summary is made by way of example and not by way of limitation. It is merely provided to aid the reader in understanding some of the aspects of the invention.

In one embodiment, a method for coating a food product comprises placing a food product including fat and moisture in a vacuum mixer, applying low temperature heat to the food product to create a heated food product, the low temperature heat being below a melting point of the fat in the food product, applying vacuum to the heated food product, adding a first flavoring to the vacuum mixer, and applying vacuum to the heated food product and the first flavoring to create a first coated food product.

In one embodiment, a method for coating pre-cooked meat comprises placing pre-cooked meat in a vacuum mixer, applying low temperature heat to the pre-cooked meat, applying vacuum to the pre-cooked meat, adding flavoring to the vacuum mixer, applying vacuum to the pre-cooked meat and the flavoring to create a coated pre-cooked meat, and removing the coated pre-cooked meat from the vacuum mixer.

In one embodiment, a method for coating pre-cooked bacon bits comprises placing pre-cooked bacon bits in a vacuum mixer, applying low temperature heat to the pre-cooked bacon bits to heat the pre-cooked bacon bits to 105 to 110° F., applying vacuum at 24 to 30 inches Hg to the pre-cooked bacon bits for 15 to 30 minutes to reduce a water activity level in the pre-cooked bacon bits to 0.55 to 0.60, adding flavoring to the vacuum mixer, applying vacuum at 24 to 30 inches Hg to the pre-cooked bacon bits and the flavoring for 8 to 12 minutes to create a coated pre-cooked bacon bits, and removing the coated pre-cooked bacon bits from the vacuum mixer.

### BRIEF DESCRIPTION OF THE DRAWINGS

The present invention can be more easily understood, and further advantages and uses thereof can be more readily apparent, when considered in view of the detailed description and the following Figures in which:

FIG. 1 illustrates a method for coating cooked meat in accordance with the principles of the present invention; and

FIG. 2 illustrates another method for coating cooked bacon bits in accordance with the principles of the present invention.

In accordance with common practice, the various described features are not drawn to scale but are drawn to emphasize specific features relevant to the present invention. Reference characters denote like elements throughout the Figures and the text.

### DETAILED DESCRIPTION OF THE INVENTION

In the following detailed description, reference is made to the accompanying drawings, which form a part hereof, and in which is shown by way of illustration embodiments in which the inventions may be practiced. These embodiments are described in sufficient detail to enable those skilled in the art to practice the invention, and it is to be understood that other embodiments may be utilized and mechanical changes may be made without departing from the spirit and scope of the present invention. The following detailed description is, therefore, not to be taken in a limiting sense, and the scope of the present invention is defined only by the claims and equivalents thereof.

Embodiments of the present invention provide methods for flavor coating meat or other food products including fat and moisture. Examples of meat that could be used include bacon, ham, and SPAM™ brand products. An example of a food product including fat and moisture is cheese. Preferably, in one example, the flavor coating is a water-soluble flavoring and the meat is high-fat, pre-cooked meat bits. Generally, the meat bits are coated with the flavoring using low temperature vacuum mixing. The low temperature is preferably less than 120° F., or any suitable temperature so that the fat in the meat does not melt, and the vacuum is preferably 24 to 30 inches Hg.

The present invention could also include multiple layers of flavor coatings applied to a food product. For example, bacon bits could be coated with a sugar mixture in a first coating step and then coated with a toffee mixture in a second coating step. For example, bacon bits could be coated with a cheese mixture in a first coating step and then coated with a bread mixture in a second coating step. To accomplish multiple layers of flavor coatings, the food product could be heated using a relatively low temperature under vacuum to sufficiently reduce moisture in the food product, the first flavoring could be added and mixed with the food product using low temperature heating under vacuum to sufficiently coat the food product with the first flavoring, and the second flavoring could be added and mixed with the coated food product using low temperature heating under vacuum to sufficiently coat the coated food product with a second flavoring. Additional coatings could be similarly layered on the coated food product.

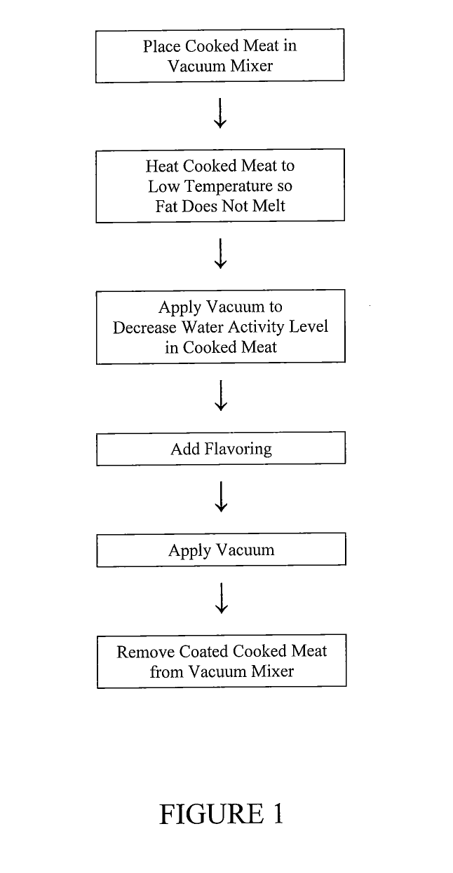

As shown in FIG. 1, one embodiment is a method for coating pre-cooked meat. The pre-cooked meat is placed in a vacuum mixer and heated to a low temperature so that the fat in the meat does not melt. A vacuum is applied to the meat to reduce the partial pressures of oxygen to induce boiling and evaporate moisture. The water activity level in the meat is reduced to create a shelf-stable product. This combination of heat and pressures allow for evaporation at a point below the melting point of the fat portion of the meat. A flavoring is added to the vacuum mixer, the mixture is held at a point near but below the maximum melting point of the fat portion of the meat, and a vacuum is applied. The evaporating moisture causes adhesion of the flavoring to the meat. The flavor coated meat is removed from the vacuum mixer.

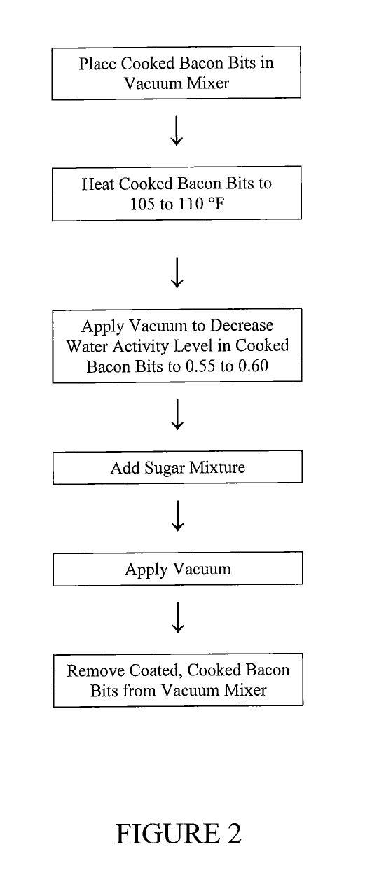

As shown in FIG. 2, one embodiment is a method for coating bacon bits with flavoring. Bacon bits, preferably having a size of ½ inch, are placed in a vacuum mixer. Rosemary extract and liquid smoke are optionally added to the vacuum mixer. The bacon bits and the optional rosemary extract and liquid smoke are heated to a temperature of 105 to 110° F. and then subjected to a vacuum of approximately 24 to 30 inches Hg for approximately 15 to 30 minutes to decrease the water activity level from approximately 0.85 to approximately 0.55 to 0.60 in the bacon bits. This reduces moisture without melting the fat in the bacon. A flavor mixture is added to the vacuum mixer. An example of a flavor mixture that could be used is a sugar mixture including sugar, molasses, brown sugar, water, hydrocolloid powder (e.g., such as one manufactured by TIC Gums located in Maryland), rosemary extract, and liquid smoke. The bacon bits and the flavor mixture are reheated to the target temperature of 105 to 110° F. and mixed under vacuum for 8 to 12 minutes or until the coated bacon bits are free-flowing. This evaporates the moisture added with the flavoring mix, is below the melting point of the fats present, and maintains the integrity of the relatively heat-sensitive flavoring compounds. If mixed too long, the sugar mixture will separate from the bacon bits but, if not mixed long enough, it will be too sticky or gooey. The coated bacon bits are removed from the vacuum mixer and allowed to cool prior to packaging.

Although bacon bits are coated with a sugar mixture in the above example, it has also been found that a cheese mixture (e.g., VELVEETA® brand processed cheese) or other types of water soluble flavorings could also be used to coat bacon or other relatively high-fat, pre-cooked meat or other food products including fat and moisture using this method. Other examples of possible types of water soluble flavorings could include caramel, teriyaki, chocolate, and marshmallow.

The key features of this invention are using a low temperature range with vacuum mixing to minimize the melting of fat and to maximize the removal of moisture from the meat. This results in a flavor coated, pre-cooked meat product that is shelf-stable and that could be used as a topping or as an ingredient.

### Example 1

The purpose of an initial test was to develop a shelf-stable, candy coated meat product for use as a topping or an ingredient. An example is bacon bits coated with a candy coating. From this test, it was determined that bacon bits should preferably have a water activity level of less than 0.50 to ensure that the candy coating remains crispy during storage.

Bacon bits that were oil cooked to a water activity level of less than 0.50 were obtained and added to a tumbler. Xanthan gum and maltodextrin were added to the tumbler and mixed with the bacon bits. An initial layer of sugar, corn syrup, and flavoring were added and mixed using a spoon or spray nozzle while tumbling, and then dextrose was added and tumbled. This was repeated until the coating was complete. The product was packaged in nitrogen back-flushed bags with an oxygen scavenger.

This initial test was unsatisfactory because it resulted in a bulky, fragile coating with little adhesion to the bacon bits. It also contained a higher-than acceptable moisture level that had unacceptable sensory characteristics.

### Example 2

Candied bacon pieces were made using the ingredients listed in Table 1.

TABLE 1
Candied Bacon Ingredients

| Ingredient | Amount (grams) |
|---|---|
| Bacon Pieces | 400.00 |
| Xanthan Gum | 1.00 |
| Maltrin 100 | 19.00 |
| Panning Syrup (Flavor: AS10003 MI 1) | 240.00 |
| Powdered Sugar | 30.00 |

Maltodextrin (Maltrin 100) and xanthan gum were mixed together and then the bacon pieces were coated with the mixture and tumbled in a panner.

The panning syrup was made using the ingredients listed in Table 2. The panning syrup was made by combining sugar, corn syrup, and water in a pot and then heating to 330° F. while stirring constantly. The mixture was allowed to cool to 315° F. Flavor was added and mixed well.

TABLE 2
Panning Syrup Ingredients

| Ingredient | Amount (grams) |
|---|---|
| Sucrose, fine granular | 600.00 |
| Corn Syrup (42/43 DE) | 135.00 |
| Water | 65.00 |
| Brown Sugar Flavor (Nat Wonf) (Flavor: 814.0001 U) | 15.00 |

The temperature of the panning syrup was held at approximately 300 to 310° F. while panning onto the bacon pieces. 120 grams of panning syrup was slowly drizzled onto the bacon pieces. The panner was then tumbled with the fan blowing air into the panner for 2 to 3 minutes. The fan was turned off, the powdered sugar was added, and then the panner was tumbled for 1 minute. 120 grams of panning syrup was slowly drizzled onto the bacon pieces. The panner was then tumbled with the fan blowing air into the panner for 2 to 3 minutes.

This test was unsatisfactory because, although it resulted in product that had closer to acceptable sensory characteristics, bacon fat rendered out and mixed with the coating. The adhesion of the coating on the bacon bits was marginally acceptable but did not meet the sensory characteristics desired.

### Example 3

Candy coated bacon bits were made by placing 227 grams bacon bits, 93.5 grams granulated sugar, 93.5 grams brown sugar, and 50 grams water in a kettle on a cooking stove. Heat was applied and the mixture was brought to a boil. The mixture was stirred while the sugar crystallized. Once the sugar melted and adhered to the bacon bits, the product was removed and allowed to cool.

This test was unsatisfactory because rendered fat reduced adhesion of the coating on the bacon bits.

### Example 4

Candy coated bacon bits were made by placing 227 grams bacon bits, 93.5 grams granulated sugar, 93.5 grams brown sugar, and 50 grams water in a kettle on a cooking stove. Heat was applied and the mixture was brought to a boil. The mixture was stirred while the sugar crystallized. Once the sugar melted, adhered to the bacon bits and became sticky, 75 grams dry sugar mixture (50% white granulated sugar and 50% brown granulated sugar) was added to the mixture and the mixture was stirred. The dry sugar mixture was used as a separating agent and allowed the batch to grain further. The product was removed and allowed to cool.

This test was unsatisfactory because rendered fat reduced adhesion of the coating on the bacon bits.

### Example 5

Sugar shell pan coated bacon bits were made by tumbling 300 grams of bacon bits in a ribbed revolving pan and applying 246 grams colored coating using a Latini chocolate spray system. The colored coating was made with 500 grams Kreemy white coating (Blommer) and 2 grams brown color (Opatint Natural G-16536N). Approximately 40 grams of gum solution (Colorcon GO-8-19019) was added to 546 grams coated bacon bits, or an amount sufficient to evenly wet the bacon bits. Once coated, approximately 225 grams powdered sugar was applied to dry up the bacon bits. The mixture was tumbled until smooth and then it was placed on a tray to dry overnight at room temperature. The following day, the sub coated bacon bits were placed into the ribbed revolving pan and a sugar syrup (100 grams 70% sugar solution and 1 gram brown color (Opatint Natural G-16536N) was applied to the bacon bits using traditional hard shell panning methods. Sugar syrup was applied to the tumbling bacon bits in an amount sufficient to wet the centers and allow the centers to dry while applying room temperature air. This was continued until the syrup is used up or the desired shell thickness was achieved.

This test was unsatisfactory because the product lacked a crunchy coating and had an unacceptable appearance. The bacon bits were coated using fat based systems.

### Example 6

Coated bacon bits were made using the ingredients listed in Table 3. The sugars were dry blended and then the TICAPAN™ Quick Crunch, manufactured by TIC Gums located in Maryland, and water were added. The mixture was heated to boil at approximately 222° F. A lower temperature was used because the vacuum will remove some moisture. The bacon bits were added and then the mixture was placed in a vacuum. Vacuum was applied for 5 minutes reaching 25 inches Hg vacuum. The mixture was removed and syrup was removed using a sieve for approximately 10 minutes. The strained mixture was placed in an oven at 104° F. for approximately 17 hours.

This test was unsatisfactory because the sugar did not adhere properly to the bacon bits due to fat melting.

TABLE 3
Ingredients

| Ingredient | Amount (grams) |
|---|---|
| Sugar, Granulated | 124.67 |
| Brown Sugar | 62.33 |
| Water | 100.00 |
| TICAPAN ™ Quick Crunch | 2.00 |
| ½ Inch Cut Bacon Bits, Temperature 72° F. | 227.00 |

### Example 7

Coated bacon bits were made using the ingredients listed in Table 4. The sugars were dry blended and then the TICAPAN™ Quick Crunch and water were added. The mixture was heated to boil at approximately 275° F. A higher temperature than that used in Example 7 was used to reduce moisture and improve graining of the sugar because a vacuum was not used. The bacon bits were added and the heat was lowered (the flame reduced) to approximately 212° F. The bacon bits were added at a temperature of 74° F. to help keep the fat from greasing out into the sugar. An additional 102 grams of granulated sugar was added, the heat was turned off, and the mixture was mixed until grained, approximately 1 to 2 minutes. The heat was turned on, using a medium to high flame, and the mixture was stirred until the sugar appeared to be melting on the bottom of the kettle. The mixture was removed from the heat and poured onto a table to cool. The water activity level of the mixture was 0.673.

This test was unsatisfactory because the sugar did not adhere to the bacon bits due to excessive moisture evaporation due to variation in flame cooking in an open air environment.

TABLE 4
Ingredients

| Ingredient | Amount (grams) |
|---|---|
| Sugar, Granulated | 795.3764 |
| Water | 212.5386 |
| TICAPAN ™ Quick Crunch | 30.6757 |
| ½ Inch Cut Bacon Bits, Temperature 74° F. | 994.7683 |

### Example 8

Coated bacon bits were made using the ingredients listed in Table 5. A kettle was preheated to 210° F. The bacon bits were added and heated to 210° F. while mixing. A blend of sugar, brown sugar, and TICAPAN™ Quick Crunch were added while mixing. Water was added. The mixture was mixed while vacuum was applied at greater than 21 inches Hg at 210° F. for 30 to 45 minutes. The vacuum was released and the mixture was removed from the kettle, placed on a tray, and placed in a cooler.

This test was unsatisfactory because the sugar did not adhere to the bacon bits due to excessive moisture evaporation due to variation in flame cooking in an open air environment.

TABLE 5
Ingredients

| Ingredient | Amount (pounds) |
|---|---|
| ½ Inch Cut Bacon Bits | 5.000 |
| Water | 0.745 |
| Sugar | 1.360 |
| Brown Sugar | 0.685 |
| TICAPAN ™ Quick Crunch | 0.0215 |

### Example 9

Similar ingredients were used as in Example 9. The bacon bits were heated, water was added, and then the bacon was heated to 210° F. A blend of sugar, brown sugar, and TICAPAN™ Quick Crunch was added. A vacuum of greater than 24 inches Hg was applied for 30 to 60 minutes to drive off moisture from the mixture resulting in re-graining of sugar molecules to provide a crunchy texture. The product was cooled and then packaged.

This test was unsatisfactory because the sugar did not adhere to the bacon bits due to excessive vacuum time.

### Example 10

Coated bacon bits were made. A fire cooked syrup formula was used similar to that used in Example 7. The formula should include either caramel coloring or molasses so that the sugar looks more like the bacon bits. The sugar and molasses mixture was placed in a vacuum mixer and slowly heated to approximately 230° F. Bacon bits having a temperature of approximately 34° F. were added and mixed for approximately 1 minute with heat. The temperature to which the bacon bits were exposed was reduced to minimize falling out, which contributes to slow crystal formation. Falling out refers to a condition where too little water remains for the sugar to be confined in solution and the sugar re-crystallizes into large crystals and a grainy appearance results. The heat was removed and a vacuum was applied at 28 inches Hg for 35 minutes. The product was removed from the mixer, cooled using a jacket cooler, and packaged. When made in larger batches, the sugar may grain out faster so the temperature may need to be reduced.

This test was unsatisfactory because higher cook temperatures resulted in fat melting and poor sugar adherence.

### Example 11

Coated bacon bits were made. A fire cooked syrup formula was used similar to that used in Example 7. The formula should include either caramel coloring or molasses so that the sugar looks more like the bacon bits. The sugar and molasses mixture was placed in a steam kettle and slowly heated to approximately 240° F. The mixture was then transferred to a vacuum mixer. Bacon bits having a temperature of approximately 34° F. were added and mixed for approximately 2 minutes with steam heat. A temperature of approximately 240° F. was maintained during mixing. A vacuum was applied at 28 inches Hg for 15 minutes during mixing, and then the mixing was stopped while the vacuum continued for an additional 15 minutes. Jacketed cooling was turned on to chill the product. The product was removed from the mixer, cooled using a jacket cooler, and packaged in nitrogen back-flushed bags.

This test was unsatisfactory because higher cook temperatures resulted in fat melting and poor sugar adherence.

### Example 12

Coated bacon bits were made by adding bacon bits with a starting temperature of 58.5° F. to a mixer and heating the bacon bits to 95° F. for 5 minutes. Sugar, gum blend, and 0.2 pounds of water were added and mixed with the bacon bits using speed setting 2. A vacuum was pulled to 28 inches Hg and the mixture was mixed for 25 minutes. The produce was cooled and placed on trays. The product was packaged in back-flushed foil pouches.

This test was unsatisfactory because the use of dry sugar without a syrup resulted in the sugar not adhering to the surface of the bacon bits.

### Example 13

Coated bacon bits were made by adding bacon bits to a mixer and heating the bacon bits to 95° F. for 5 minutes. Sugar, gum blend, and water were placed in a pan, heated to 230° F., and then added to the bacon bits in the mixer and mixed for 2 minutes. A vacuum was pulled to 28 inches Hg and the mixture was mixed for 25 minutes. The produce was cooled and placed on trays. The product was packaged in back-flushed foil pouches.

This test was unsatisfactory because the high temperature resulted in bacon fat separating and leading to loss of sugar coating of the surface of the bacon bits.

### Example 14

Coated bacon bits were made with the ingredients listed in Table 6. The bacon bits were heated to 105° F. in a mixer with agitation on speed 2. A dry blend of sugar, brown sugar, and TICAPAN™ Quick Crunch were added and mixed with the bacon bits. The water and molasses were added slowly while mixing. The temperature was set to 105° F. and vacuum was applied for 40 minutes. The product was removed and allowed to cool before being packaged. From this process, it was determined that a deeper vacuum should be used to reduce the vacuum time.

This test was unsatisfactory because a lack of deep vacuum resulted in product failure and extended processing times.

TABLE 6
Ingredients

| Ingredient | Amount (pounds) |
|---|---|
| Bacon Bits | 10.00 |
| Sugar, Granulated | 3.57 |
| Molasses | 0.15 |
| TICAPAN ™ Quick Crunch | 0.13 |
| Brown Sugar | 2.09 |
| Water | 0.40 |

### Example 15

Bacon bits were heated to 105° F. Sugar, water, and molasses were heated on a stovetop to 240° F. to create a sugar mixture. The sugar mixture was added to the bacon bits in a vacuum mixer and mixed for 2 minutes. Vacuum at 27 inches Hg was applied until the temperature of the product was raised 5° F. The vacuum was stopped and the product was allowed to cool. The cooled product was packaged in nitrogen back-flushed bags and stored refrigerated. This process failed because the sugar grained out.

This test was unsatisfactory because the sugar did not adhere to surface of the bacon bits due to extended vacuum times.

### Example 16

Coated bacon bits were made with the ingredients listed in Table 7. The bacon bits were placed in a vacuum mixer and heated to 105° F. A vacuum at greater than 24 inches Hg was pulled on the heated bacon bits and mixed for 5 minutes. All of the other ingredients were mixed to create a sugar syrup, which was added to the mixer. A vacuum at greater than 24 inches Hg was applied to the mixture for 5 minutes. The product was removed from the mixer and allowed to cool. The product was packaged in nitrogen back-flushed bags. This process resulted in a successful product.

This was a successful test, however, the flavor sensory characteristics of the product were not acceptable.

TABLE 7
Ingredients

| Ingredient | Amount (grams) |
|---|---|
| ½ Inch, Single Cook, Bacon Bits | 4540 |
| Sugar, Granulated | 2280 |
| Molasses | 100 |
| Brown Sugar | 1340 |
| Water | 1000 |
| TICAPAN ™ Quick Crunch | 73.2 |
| Rosemary Extract | 3.67 |

### Example 17

Bacon bits, rosemary extract, and liquid smoke were added to a vacuum mixer. Heat was applied to the vacuum mixer until the bacon bits reached a temperature of 105 to 110° F. The temperature was low enough so as to not melt the fat in the bacon bits. Vacuum of approximately 27 inches Hg was applied to the vacuum mixer for 15 to 30 minutes to lower the water activity level of the bacon bits mixture from approximately 0.85 to approximately 0.55 to 0.60 to assist in creating a shelf-stable product. A sugar water solution including sugar, molasses, brown sugar, water, rosemary extract, liquid smoke, and TICAPAN™ Quick Crunch was added to the vacuum mixer. Although TICAPAN™ Quick Crunch was used, it is recognized that this ingredient is optional. Although a blend of sugar and brown sugar was used, it is recognized that any suitable type of sugar could be used. The ingredients are listed in Table 8.

TABLE 8
Ingredients

| Ingredient | Amount (grams) |
|---|---|
| ½ Inch Bacon Bits | 4540 |
| Sugar | 2280 |
| Molasses | 100 |
| Brown Sugar | 1340 |
| Water | 750 |
| TICAPAN ™ Quick Crunch | 73.2 |
| Rosemary Extract | 3.67 |
| Liquid Smoke | 0.1 |

The ingredients were mixed in the vacuum mixer under vacuum of approximately 27 inches Hg for 8 to 12 minutes until free-flowing and the sugar began to grain. The color lightened significantly. The product was removed from the vacuum mixer and allowed to cool before being placed in nitrogen back-flushed packages.

This test resulted in a satisfactory product.

### Example 18

Bacon bits, rosemary extract, and liquid smoke were added to a vacuum mixer. Heat was applied to the vacuum mixer until the bacon bits reached a temperature of 105 to 110° F. Vacuum of approximately 27 inches Hg was applied to the vacuum mixer for approximately 30 minutes to reach a water activity level of 0.55 to 0.60 in the bacon bits. A sugar water solution including sugar, molasses, brown sugar, water, rosemary extract, liquid smoke, and TICAPAN™ Quick Crunch was added to the vacuum mixer. Although TICAPAN™ Quick Crunch was used, it is recognized that this ingredient is optional. Although a blend of sugar and brown sugar was used, it is recognized that any suitable type of sugar could be used. Formulas including reduced sugar of 25%, 35%, and 50% were made, and the ingredients for each formula are listed in Table 9. The sugar was hydrated to create a wet paste-like sugar mixture that adhered to the bacon bits.

TABLE 9
Ingredients for 25%, 35%, and 50% Reduced Sugar Formulas

| | Amount | Amount | Amount |
|---|---|---|---|
| | (grams) for | (grams) for | (grams) for |
| Ingredient | 25% Reduction | 35% Reduction | 50% Reduction |
| ½ Inch Bacon Bits | 4540 | 4540 | 4540 |
| Sugar | 1710 | 1482 | 1140 |
| Molasses | 75 | 65 | 50 |
| Brown Sugar | 1005 | 871 | 670 |
| Water | 562.50 | 487.50 | 375 |
| TICAPAN ™ Quick | 54.90 | 47.58 | 36.60 |
| Crunch | | | |
| Rosemary Extract | 3.67 | 3.67 | 3.67 |
| Liquid Smoke | 0.1 | 0.1 | 0.1 |

The ingredients were mixed in the vacuum mixer under vacuum of approximately 27 inches Hg until free-flowing and the sugar began to grain. For the 25% formula, the ingredients were mixed for approximately 7.5 minutes. For the 35% formula, the ingredients were mixed for approximately 7.5 minutes. For the 50% formula, the ingredients were mixed for approximately 4.3 minutes. The moisture flashed off of the sugar mixture so that the sugar crystallized on the surface of the bacon bits and still adhered to the bacon bits. The color lightened significantly. The water activity level was 0.60 for the product including the 25% reduced sugar formula, the water activity level was 0.638 for the product including the 35% reduced sugar formula, and the water activity level was 0.564 for the product including the 50% reduced sugar formula. The product was removed from the vacuum mixer and allowed to cool before being placed in nitrogen back-flushed packages.

This test resulted in a satisfactory product.

The above specification, examples, and data provide a complete description of the manufacture and use of the composition of embodiments of the invention. Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the invention. Therefore, it is manifestly intended that this invention be limited only by the claims and the equivalents thereof.

1. A method for coating a food product, comprising:
placing a food product including fat and moisture in a vacuum mixer;
applying low temperature heat to the food product to create a heated food product, the low temperature heat being below a melting point of the fat in the food product;
applying vacuum to the heated food product;
adding a first flavoring to the vacuum mixer; and
applying vacuum to the heated food product and the first flavoring to create a first coated food product.

2. The method of claim 1, further comprising adding a second flavoring to the vacuum mixer and applying vacuum to the first coated food product and the second flavoring to create a second coated food product.

3. The method of claim 1, wherein the food product is selected from the group consisting of meat and cheese.

4. The method of claim 1, wherein the low temperature heat is applied during the vacuum application steps.

5. A method for coating pre-cooked meat, comprising:
placing pre-cooked meat in a vacuum mixer;
applying low temperature heat to the pre-cooked meat;
applying vacuum to the pre-cooked meat;
adding flavoring to the vacuum mixer;
applying vacuum to the pre-cooked meat and the flavoring to create a coated pre-cooked meat; and
removing the coated pre-cooked meat from the vacuum mixer.

6. The method of claim 5, wherein the pre-cooked meat is a high-fat meat.

7. The method of claim 5, wherein the pre-cooked meat is selected from the group consisting of bacon bits, ham, and a SPAM brand product.

8. The method of claim 5, wherein the low temperature heat heats the pre-cooked meat to 105 to 110° F.

9. The method of claim 5, wherein the vacuum is applied to the pre-cooked meat to reduce a water activity level in the pre-cooked meat to 0.55 to 0.60.

10. The method of claim 5, wherein the vacuum is 24 to 30 inches Hg.

11. The method of claim 10, wherein the vacuum is applied to the pre-cooked meat for 15 to 30 minutes.

12. The method of claim 10, wherein the vacuum is applied to the pre-cooked meat and the flavoring for 8 to 12 minutes.

13. The method of claim 5, wherein the flavoring is a water soluble flavoring.

14. The method of claim 5, wherein the flavoring is a flavoring selected from the group consisting of a liquid flavoring and a dry water soluble flavoring mixed with water.

15. The method of claim 5, wherein the flavoring is a flavoring selected from the group consisting of a sugar mixture and a cheese mixture.

16. The method of claim 5, wherein the low temperature heat is applied during the vacuum application steps.

17. A method for coating pre-cooked bacon bits, comprising:
placing pre-cooked bacon bits in a vacuum mixer;
applying low temperature heat to the pre-cooked bacon bits to heat the pre-cooked bacon bits to 105 to 110° F.;
applying vacuum at 24 to 30 inches Hg to the pre-cooked bacon bits for 15 to 30 minutes to reduce a water activity level in the pre-cooked bacon bits to 0.55 to 0.60;
adding flavoring to the vacuum mixer;
applying vacuum at 24 to 30 inches Hg to the pre-cooked bacon bits and the flavoring for 8 to 12 minutes to create a coated pre-cooked bacon bits; and
removing the coated pre-cooked bacon bits from the vacuum mixer.

18. The method of claim 17, wherein the flavoring is a water soluble flavoring.

19. The method of claim 17, wherein the flavoring is a flavoring selected from the group consisting of a liquid flavoring and a dry water soluble flavoring mixed with water.

20. The method of claim 17, wherein the flavoring is a flavoring selected from the group consisting of a sugar mixture and a cheese mixture.

21. The method of claim 17, wherein rosemary extract and liquid smoke are added to the vacuum mixer before heating the pre-cooked bacon bits.

22. The method of claim 17, wherein the low temperature heat is applied during the vacuum application steps.
